(19) United States
(12) Patent Application Publication
(10) Pub. No.: US 2026/0330996 A1
(43) Pub. Date: Oct. 22, 2026

(54) WRIST POSITION GUIDE APPARATUS FOR STRINGED INSTRUMENTS NECK

(71) Applicants: Sean-Paul Shulte, Moab, UT (US); Kenneth A. Rubin, Naples, FL (US)

(72) Inventors: Sean-Paul Shulte, Moab, UT (US); Kenneth A. Rubin, Naples, FL (US)

(21) Appl. No.: 19/184,074

(22) Filed: Apr. 21, 2025

(51) Int. Cl. G09B 15/06

(52) U.S. Cl. CPC G09B 15/06

(57) ABSTRACT

A wrist position guide apparatus for a string instrument's neck, comprising a body with a first end and a second end, a neck-engaging surface, a flat surface, and a curved guide surface. The body is designed to removably attach to the neck portion of the string instrument, guiding the user's thumb and maintaining the user's wrist in an ergonomically correct position during play. The curved guide surface includes a concave arc to receive and guide the user's thumb, while the neck-engaging surface features an arcuate channel to conform to the back surface of the neck portion. The apparatus also includes at least one fastening mechanism, such as a hook and loop fastener, adhesive, or adjustable strap, to secure the body to the neck portion. The flat surface is smooth to allow the user's thumb to easily move across it.

### FIELD OF THE INVENTION

The present invention pertains generally to devices designed to aid in maintaining proper hand and wrist positioning while playing a string instrument, and more specifically to an apparatus that guides the wrist position of a player to ensure an ergonomically correct posture.

### BACKGROUND OF THE INVENTION

Proper wrist positioning is essential for string instrument players to achieve optimal performance and prevent injury. When playing string instruments such as guitars, violins, or bass, the player's wrist must maintain specific ergonomic alignment with respect to the instrument's neck to facilitate proper fretting technique, string access, and advanced playing methods. This alignment is particularly critical in the fretting hand, where improper positioning can limit finger mobility, reduce playing efficiency, and potentially lead to repetitive stress injuries. Despite its importance, many players, especially those in early stages of learning, frequently struggle to maintain correct wrist positioning during practice and performance.

Traditional teaching methods for string instrument instruction predominantly rely on verbal direction and visual demonstration to communicate proper wrist positioning techniques. These conventional approaches typically involve an instructor demonstrating the correct position while explaining the anatomical principles and technical benefits. The student then attempts to replicate this position through observation and trial-and-error. However, without continuous physical feedback, students often struggle to consistently maintain proper positioning, particularly when transitioning between different playing techniques or positions on the instrument's neck.

The limitations of traditional instruction methods become particularly evident during independent practice sessions. Without real-time feedback or physical guidance, players frequently deviate from correct form, especially when concentrating on other aspects of playing such as note accuracy, rhythm, or complex finger patterns. This deviation can occur gradually and unconsciously, leading to the development of improper muscle memory patterns that become increasingly difficult to correct over time. The problem is compounded by the fact that players often cannot accurately observe their own wrist position while focusing on the fretboard during practice.

While some players seek to address these challenges through frequent lessons with qualified instructors, this solution presents both practical and economic barriers. Professional instruction typically involves significant financial investment and is limited by instructor availability and scheduling constraints. Moreover, even with regular instruction, the majority of a player's practice time occurs independently, during which incorrect habits may develop or persist. The financial burden of frequent lessons can be particularly prohibitive for beginning students, who paradoxically need the most guidance in developing proper technique.

Furthermore, existing practice aids and teaching tools have not adequately addressed the specific challenge of maintaining proper wrist positioning. While various devices exist to assist with finger placement, string height, and other technical aspects of playing, there remains a notable absence of effective solutions for providing consistent, physical feedback for wrist positioning during practice sessions. This gap in available teaching aids has left both instructors and students without reliable tools for developing and maintaining proper wrist technique.

Therefore, there is a need for an improved solution for maintaining correct wrist positioning while playing a string instrument, enhancing the player's technique and reducing the risk of strain or injury.

### SUMMARY OF THE INVENTION

The present invention pertains to a wrist position guide apparatus for a string instrument's neck, designed to maintain the user's wrist in an ergonomically correct position during play. The apparatus comprises a body with a first end and a second end, a neck-engaging surface on one side, a flat surface on the top, and a curved guide surface on the bottom. The neck-engaging surface can be contoured to complementarily mate with the neck portion of the string instrument, and the body can be configured to removably attach to the neck portion. The curved guide surface can include a concave arc designed to receive and guide the user's thumb, while the neck-engaging surface comprises an arcuate channel configured to conform to the back surface of the neck portion.

The apparatus can also have at least one fastening mechanism to secure the body to the neck portion, which may be a hook and loop fastener, adhesive, or adjustable strap. The body of the apparatus can be constructed from various materials, including molded plastic, wood, metal, and composite materials. The first and second ends of the body can be tapered to facilitate sliding movement along the neck portion, and the flat surface is smooth to allow the user's thumb to easily move across it.

The body can have a length dimension selected to accommodate at least three frets of the string instrument. The apparatus may also include padding material on the curved guide surface to enhance user comfort, and at least one thumb spot and/or at least one finger dot. These spots and dots are repositionable along the length and perimeter of the neck portion and the fret side of the stringed instrument, respectively. The apparatus can be adjusted on the string instrument's neck along its length and/or perimeter to flatten a user's wrist when playing.

The invention can include a method for positioning a user's wrist during play of a string instrument, which involves providing the wrist position guide apparatus, removably attaching the body to the neck portion of the string instrument and engaging the user's thumb with the curved guide surface during play. This method maintains the user's wrist in an ergonomically correct position relative to the neck portion, which involves positioning the user's wrist such that there is a substantially straight alignment between the user's forearm, wrist, and hand.

The method can involve sliding the body along the neck portion to reposition the curved guide surface for different playing positions, providing at least one repositionable thumb spot and finger dot, and adjusting the position of the body along the length of the neck portion to flatten the user's wrist during play. The thumb spot and finger dot can be repositioned to accommodate different chord formations during play, and the user's thumb can be guided along the curved guide surface in a consistent motion pattern during string transitions. The position of the body can be periodically adjusted around the perimeter or length of the neck portion to accommodate different playing techniques positioning the user's wrist in the correct position.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1 shows an isometric view of the wrist position guide apparatus in accordance to one or more embodiments;

FIG. 2 shows an isometric view of the wrist position guide apparatus in accordance to one or more embodiments;

FIG. 3 shows an isometric view of the wrist position guide apparatus in accordance to one or more embodiments;

FIG. 4 shows an isometric view of the wrist position guide apparatus in accordance to one or more embodiments;

FIG. 5 shows an isometric view of the wrist position guide apparatus in accordance to one or more embodiments;

FIG. 6 shows an isometric view of the wrist position guide apparatus in accordance to one or more embodiments;

FIG. 7 shows an isometric view of the wrist position guide apparatus in accordance to one or more embodiments;

FIG. 8 shows a back view of the wrist position guide apparatus with thumb spot in accordance to one or more embodiments; and

FIG. 9 shows a back view of the wrist position guide apparatus with thumb spot in a different location in accordance to one or more embodiments;.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

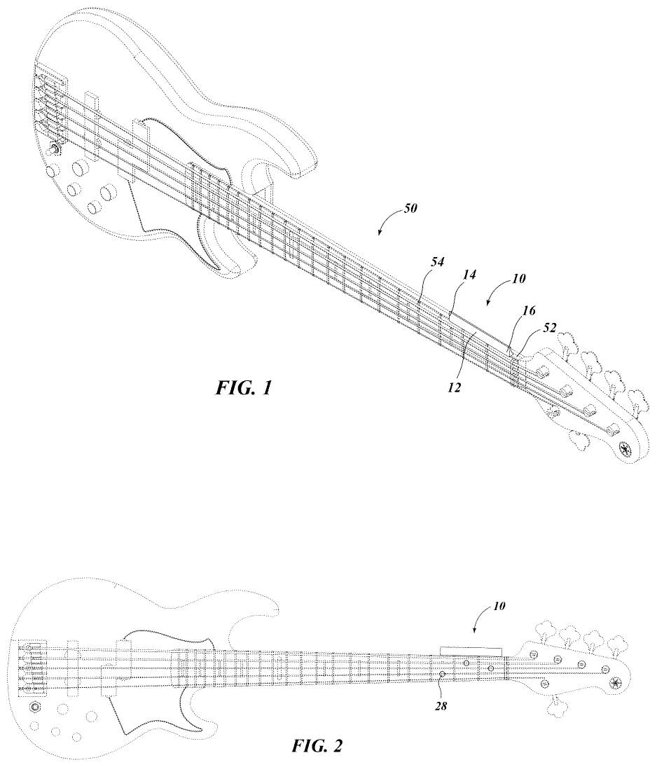

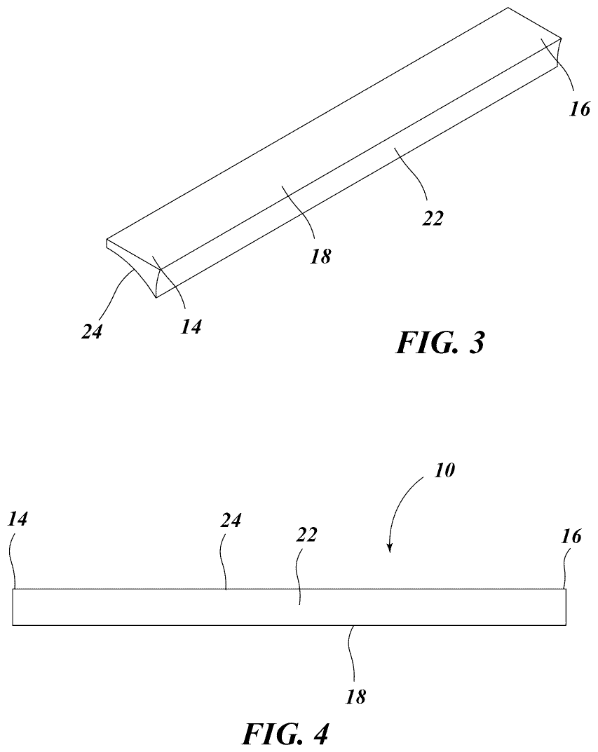

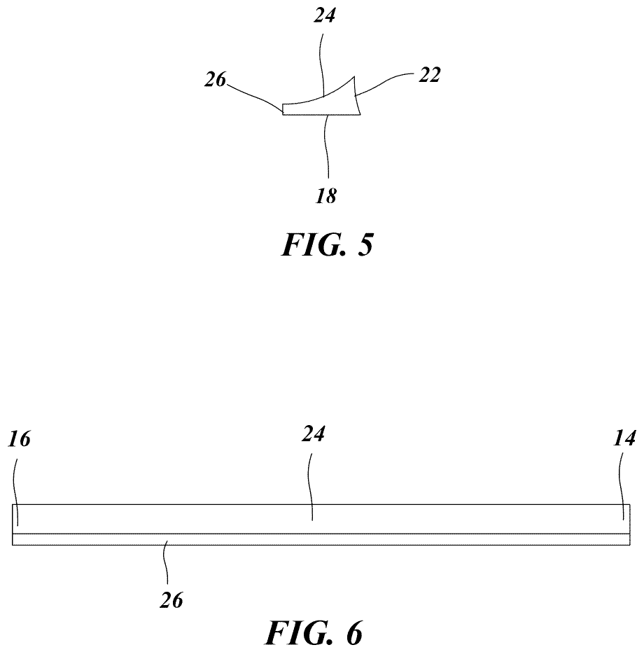

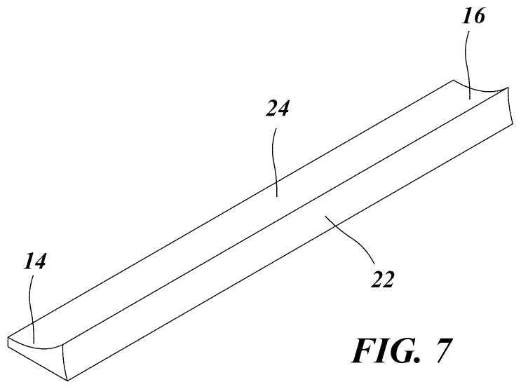

Referring initially to FIG. 1-7 a wrist position guide apparatus for a string instrument's neck is shown generally at 10. The wrist position guide system 10 can comprise a body 12 having a first end 14 and a second end 16 creating a length between the first end and the second end. The length of the body can be such as, for example, at least 1.5 inches to 12 inches and more preferrable 2 inches to 8 inches and still more preferable 3 inches to 6 inches or in other embodiments the length can be the length of a fret 54 such as, for example, at least 1 fret to 6 frets on the guitar neck. The body 12 can have a neck-engaging surface disposed on a first side 22 of the body and a second side 26 that can be substantially small in thickness than the first side, wherein the neck-engaging surface is contoured to complementarily mate with a neck portion 52 of the string instrument 50 wherein the stringed instrument can be such as, for example, guitar, bass, violin banjo, ukelele, or the like.

The body 12 can be coupled to the guitar neck by the first side 22 by a fastening mechanism which can be such as, for example, hook and loop fastener, adhesive, straps, fastener, or the like. The wrist position guide system 10 adaptable mounting system can accommodate varying neck sizes and profiles while ensuring secure placement during performance conditions. The fastening mechanism can incorporate a stress-distribution system that allows for rapid removal without creating potentially damaging stress points on the instrument's neck or finish. The body 12 can be made from such as, for example, plastics, rubber, metal, wood, polymers, or any combination thereof. The material combinations can allow for optimized performance characteristics such as controlled compression set, enhanced vibration dampening, and resistance to environmental factors while maintaining instrument-safe contact surfaces. The system 10 can be coupled to the instrument in varying locations down the neck of the instrument as shown in FIG. 1 and FIG. 9, or multiple apparatus can be coupled to the neck of the instrument.

The wrist position guide system 10 can have a flat surface disposed on a top side 18 of the body and a curved guide surface disposed on a bottom side 24 of the body wherein when the body is removably attach to the neck portion of the string instrument a user's thumb can engage the curved guide surface during play and the user's wrist is maintained in an ergonomically correct position relative to the neck portion. The curved guide surface on the bottom side 24 is biomechanically optimized to guide the player's thumb into an ideal contact position while simultaneously influencing proper wrist alignment. The system 10 can achieves this through dynamic thumb guidance providing tactile feedback, proprioceptive alignment using the flat and curved surfaces as reference points, biomechanical load distribution across the wrist joint's natural range of motion, and adaptive positioning that accommodates various playing styles while maintaining ergonomically sound wrist positions. The second side 26 can be sized accordingly to fit a smaller stringed instrument such as a violin or ukelele wherein the first side 22 can be sized to fit a larger instrument such as a bass or guitar wherein any of the sides can be attached to the stringed instruments.

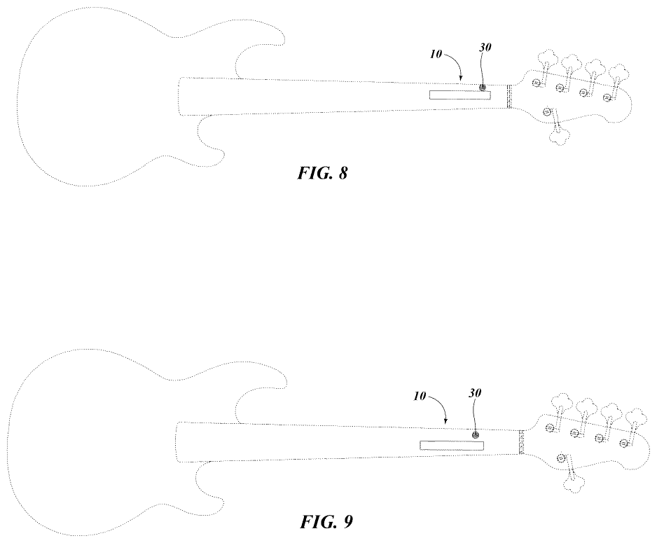

In certain embodiments, the system 10 comprises a plurality of tactile indicators strategically placed on key contact points of a stringed instrument to provide position feedback during play. The system 10 includes at least one thumb spots 30 positioned on the neck portion 52 of the stringed instrument and at least one finger dot 28 positioned on the fret 54 side of the stringed instrument, as illustrated in FIGS. 2 and 8. The thumb spots 30 and finger dots 28 function as visual and/or tactile indicators that provide sensory feedback to the user during instrument operation. The thumb spots 30 and finger dots 28 can be fabricated in various geometrical configurations, including but not limited to circular, oval, rectangular, triangular, or custom ergonomic shapes. The dimensions of these tactile indicators may range from approximately 2 millimeters to 15 millimeters in diameter or width, and from 0.5 millimeters to 5 millimeters in height or thickness. These dimensional parameters enable the user to detect the tactile indicators through touch sensation without significantly impeding instrument playability. In some embodiments, the thumb spots 30 and finger dots 28 can be manufactured from materials such as, for example, silicone, rubber, polymer composites, textile-based materials, or other tactilely distinct substances that provide sufficient friction coefficient to maintain hand positioning while preventing unwanted slippage during play.

The thumb spot 30 may have a thickness and a circular cutout in the center of the thumb spot 30, allowing the user to easily center their thumb in the center or other desired position on the thumb spot. The finger dots 28 may be positioned on the fretboard to show the fingering of an open chord. In a particular embodiment, the finger dots 28 may be color coordinated to show the fingering for different commonly used open chords.

In certain embodiments, the thumb spots 30 and finger dots 28 can be adjustable wherein the thumb spots 30 can be repositionable along the length and perimeter of the neck portion 52, and the finger dots 28 can be configured to be repositionable along the fret 54 side of the stringed instrument, as shown in FIGS. 8 and 9. This adjustability accommodates variations in user anatomical configurations, playing styles, and educational progression. Specifically, the tactile indicators can be adjusted to account for factors such as, for example, variations in hand size among different users; different playing positions required for various musical techniques; changes in optimal positioning as the user's skill level advances; accommodation of different chord structures and scale patterns; adaptation to different stringed instrument types and configurations, or the like.

The thumb spots 30 and the finger dots 28 can be attached by such as, for example, a releasable adhesive backing, micro-suction technology, hook-and-loop fasteners, magnetic coupling systems, or other removable attachment means that maintain secure positioning during play while allowing for repositioning as needed. In some embodiments, the tactile indicators incorporate visual differentiation features, such as color-coding or distinct patterns, to facilitate learning of proper hand positioning through complementary visual and tactile feedback modalities. The thumb spots 30 and finger dots 28 can work in conjunction with the system 10 to position the user's wrist properly during play.

The curved guide surface on the bottom side 24 can be such as, for example, a concave arc, convex arc, compound curve, asymmetric profile, parabolic curve, ergonomic thumb groove, anatomically-contoured channel, multi-radius surface, biomechanically-optimized depression, variable-depth recess, graduated curve transition, physiologically-mapped indent, spline-based profile, dual-zone curvature, hybrid arc-flat surface, anthropometrically-derived contour, progressive radius formation, anatomical thumb cradle, or the like.

These surface profiles can be further enhanced with tactile-feedback regions, pressure-distribution zones, and wear-resistant materials to optimize player comfort and proper thumb positioning during extended playing sessions. The innovative surface geometries are designed to accommodate different playing styles and hand sizes while maintaining optimal ergonomic alignment. The wrist position guide system 10 can help a stringed instrument player or the instructor position the player's wrist until the player's wrist is flat and in the proper position. The wrist position guide system 10 can be adjusted around the neck's circumference or up and the down the length of the instruments neck.

In certain embodiments, the curved guide surface on the bottom side 24 can be configured with multiple curvature profiles including a gentle parabolic arc for classical technique, a compound curve with dual radius sections for contemporary playing styles, or an asymmetric profile optimized for specific playing techniques. Additionally, the curved surface can incorporate selective compression zones using materials of different durometers, allowing areas of firmer support for proper positioning while maintaining comfort through softer contact regions. The curved guide surface on the bottom side 24 can be configured with multiple curvature profiles including a gentle parabolic arc for classical technique, a compound curve with dual radius sections for contemporary playing styles, or an asymmetric profile optimized for specific playing techniques.

In certain embodiments, one side 14, 16, 24 may have a radius of curvature designed to match a common radius of curvature of a guitar or bass guitar and another side may have a radius of curvature configured to match the greater radius of curvature of a smaller instrument such as a fiddle or viola. The flat side 18 may have a recessed logo.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A wrist position guide apparatus for a string instrument's neck, comprising:
a body having a first end and a second end;
a neck-engaging surface disposed on a first side of the body, wherein the neck-engaging surface is contoured to complementarily mate with a neck portion of the string instrument;
a flat surface disposed on a top side of the body;
a curved guide surface disposed on a bottom side of the body wherein the body is configured to removably attach to the neck portion of the string instrument such that when a user's thumb engages the curved guide surface during play, the user's wrist is maintained in an ergonomically correct position relative to the neck portion.

2. The apparatus of claim 1, wherein the curved guide surface comprises a concave arc configured to receive and guide the user's thumb.

3. The apparatus of claim 1, wherein the neck-engaging surface comprises an arcuate channel configured to conform to a back surface of the neck portion.

4. The apparatus of claim 1, further comprising at least one fastening mechanism configured to secure the body to the neck portion.

5. The apparatus of claim 1, wherein the fastening mechanism comprises a hook and loop fastener, adhesive or adjustable strap.

6. The apparatus of claim 1, wherein the body is constructed from a material selected from the group consisting of molded plastic, wood, metal, and composite materials.

7. The apparatus of claim 1, wherein the first end and second end are tapered to facilitate sliding movement along the neck portion.

8. The apparatus of claim 1, wherein the flat surface is smooth to allow the user's thumb to easily move across the flat surface.

9. The apparatus of claim 1, wherein the body has a length dimension selected to accommodate at least three frets of the string instrument.

10. The apparatus of claim 1, further comprising padding material disposed on the curved guide surface to enhance user comfort.

11. The apparatus of claim 1, further comprising at least one thumb spots and/or at least one finger dot wherein the at least one thumb spot is repositionable along the length and perimeter of the neck portion, and the at least one finger dot is configured to be repositionable along the fret side of the stringed instrument.

12. The apparatus of claim 11, wherein the apparatus is adjusted on the string instrument's neck along its length and/or perimeter to flatten a user's wrist when playing.

13. A method for positioning a user's wrist during play of a string instrument, comprising:
providing the wrist position guide apparatus of claim 1;
removably attaching the body to the neck portion of the string instrument; and
engaging the user's thumb with the curved guide surface during play, thereby maintaining the user's wrist in an ergonomically correct position relative to the neck portion.

14. The method of claim 13, further comprising sliding the body along the neck portion to reposition the curved guide surface for different playing positions.

15. The method of claim 13, further comprising providing at least one repositionable thumb spot;
providing at least one repositionable finger dot;
positioning the at least one thumb spot along the curved guide surface at a designated thumb position; and
positioning the at least one finger dot on a fret side of the string instrument at a designated finger position.

16. The method of claim 15, further comprising adjusting the position of the body along the length of the neck portion to flatten the user's wrist during play.

17. The method of claim 15, further comprising repositioning the at least one thumb spot and the at least one finger dot to accommodate different chord formations during play.

18. The method of claim 13, further comprising guiding the user's thumb along the curved guide surface in a consistent motion pattern during string transitions.

19. The method of claim 13, wherein maintaining the user's wrist in an ergonomically correct position comprises: positioning the user's wrist such that there is a substantially straight alignment between the user's forearm, wrist, and hand.

20. The method of claim 13, further comprising: periodically adjusting the position of the body around the perimeter of the neck portion to accommodate different playing techniques.
